(19) United States
(12) Patent Application Publication
(10) Pub. No.: US 2014/0253708 A1
(43) Pub. Date: Sep. 11, 2014

(54) LOST DEVICE RETURN

(71) Applicants: Stephen Allen, Palo Alto, CA (US); Uttam K. Sengupta, Portland, OR (US)

(72) Inventors: Stephen Allen, Palo Alto, CA (US); Uttam K. Sengupta, Portland, OR (US)

(21) Appl. No.: 13/793,180

(22) Filed: Mar. 11, 2013

(51) Int. Cl. G08B 21/24

(52) U.S. Cl. CPC G08B 21/24
USPC 348/77; 704/246; 340/539.11; 340/539.13

(57) ABSTRACT

Systems, apparatus and methods of reducing or eliminating device loss are described herein. A computing device may receive a user input. The user input may include a proximity preference. The computing device may generate an alert signal upon detecting that a distance between the computing device and the user has increased beyond the first proximity preference. The detecting may be based on sensing a characteristic of the user, such as a voice characteristic or a facial characteristic, or upon detecting that a signal between a user headset and the computing device has diminished in strength.

### TECHNICAL FIELD

Embodiments described herein generally relate to computer systems. Some embodiments relate to loss prevention for computer systems.

### BACKGROUND

Users often carry their electronic devices to a variety of different locations throughout the day. Users may forget to take their devices with them when they leave a location. Some conventional systems may prevent theft of the device or prevent use of a stolen or misplaced device, but they do not prevent users from inadvertently leaving their devices.

Additionally, a second person may discover, or pick up, a misplaced device and be uncertain as to what to do with the device. Devices misplaced in an office environment may be more likely to be found by a co-worker or another person familiar with the device owner. Nevertheless, conventional systems do not provide context-sensitive assistance for returning devices.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1 and 2 are diagrams of environments in which example embodiments may be implemented.

FIG. 3 is a block diagram illustrating an example device upon which any one or more of the techniques discussed herein may be performed.

FIG. 4 is a flow diagram illustrating an example method for notifying of a lost device, according to an embodiment.

FIG. 5 is a block diagram illustrating an example device upon which any one or more techniques discussed herein may be performed.

### DESCRIPTION OF THE EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

People often carry their laptops, phones, and other electronic devices with them throughout the workday. For example, people may carry their devices to the gym, then to a conference room, then to lunch, and then back to their office. Each time a person leaves one location, there is the risk that the person will inadvertently leave his or her device at that location.

Some conventional systems may provide anti-theft features to prevent theft of devices. These systems may prevent a second party from using a lost or misplaced device. However, these conventional systems do not help prevent the device owner from leaving the device behind in the first place.

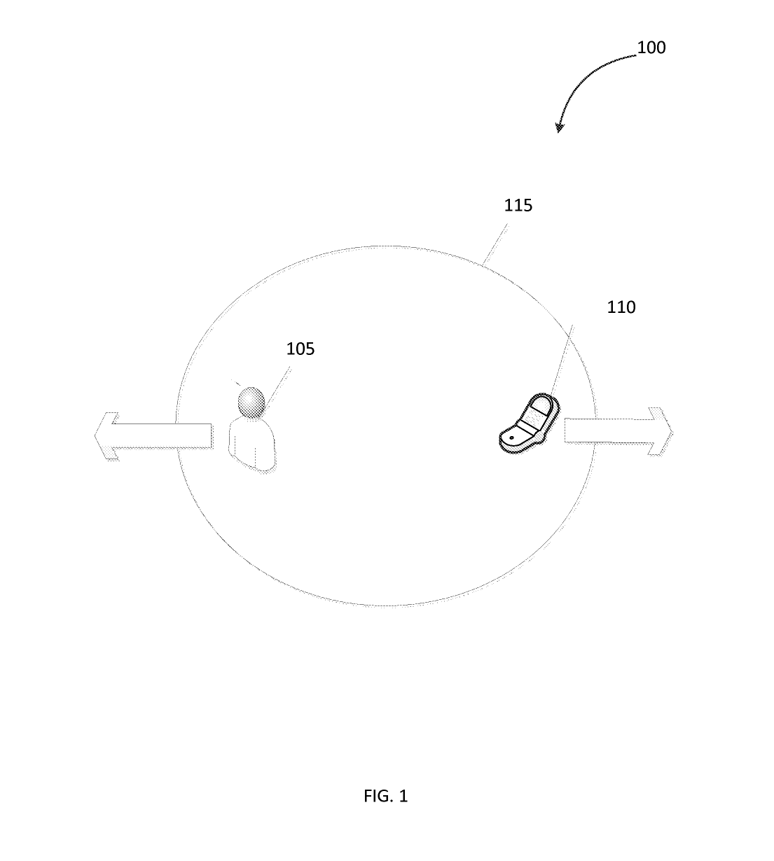

FIG. 1 is a diagram illustrating an environment 100 in which example embodiments may be implemented. The environment 100 may include a user 105 and a first electronic device 110. The electronic device 110 may be any type of mobile electronic device or resource including, for example, a laptop computer, a tablet computer, or a smartphone. The environment 100 may include one user 105 and one electronic device 110. However, it will be understood that any number of devices or users may be present.

Example embodiments may warn a device owner, for example the user 105, against potential lost devices. Example embodiments may allow a user 105 to establish one or more proximity preferences to configure a “proximity bubble” 115 between the user 105 and the device 110. In example embodiments, if either the device 110 or the user 105 moves outside the proximity bubble 115, the device 110 may generate an alert signal, as described in more detail below.

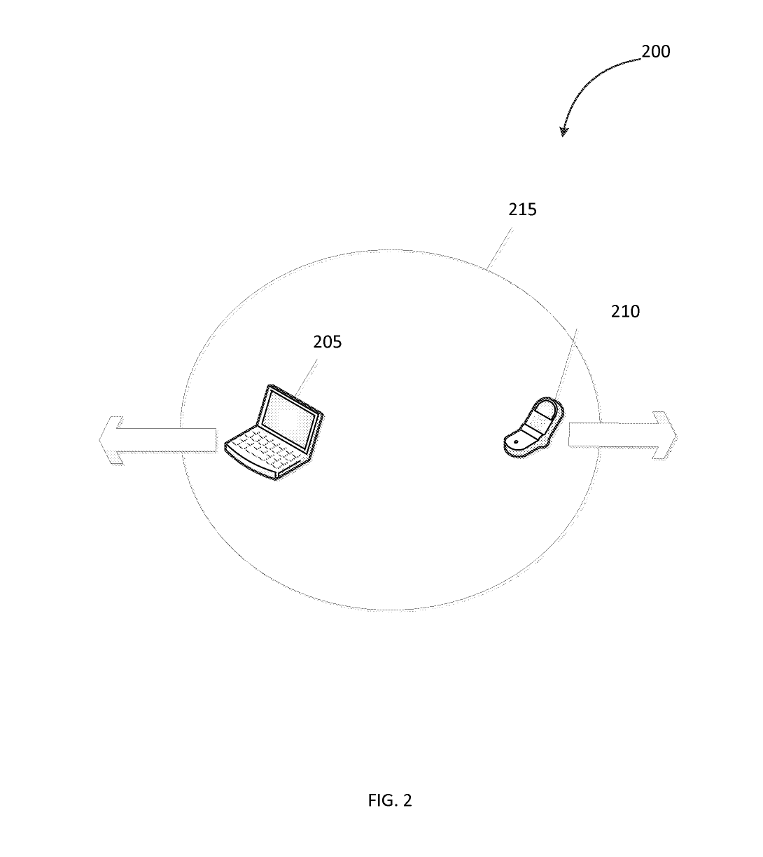

FIG. 2 is a diagram illustrating another environment 200 in which example embodiments may be implemented. The environment 200 may include a first electronic device 205 and a second electronic device 210. Example embodiments may establish a proximity bubble 215 between the first electronic device 205 and the second electronic device 210. In at least these example embodiments, the first electronic device 205 may detect that the second electronic device 210 has moved outside the proximity bubble, or vice versa. Either the first electronic device 205 or the second electronic device 210 may generate an alert, for example an audible alert, to alert the user (not shown in FIG. 2) that the “buddy” device 205 or 210 may be at risk of being misplaced.

In example embodiments, the proximity bubble 115 (FIG. 1) or 215 (FIG. 2) may be relaxed in relatively safe or familiar environments such as the user's office or home.

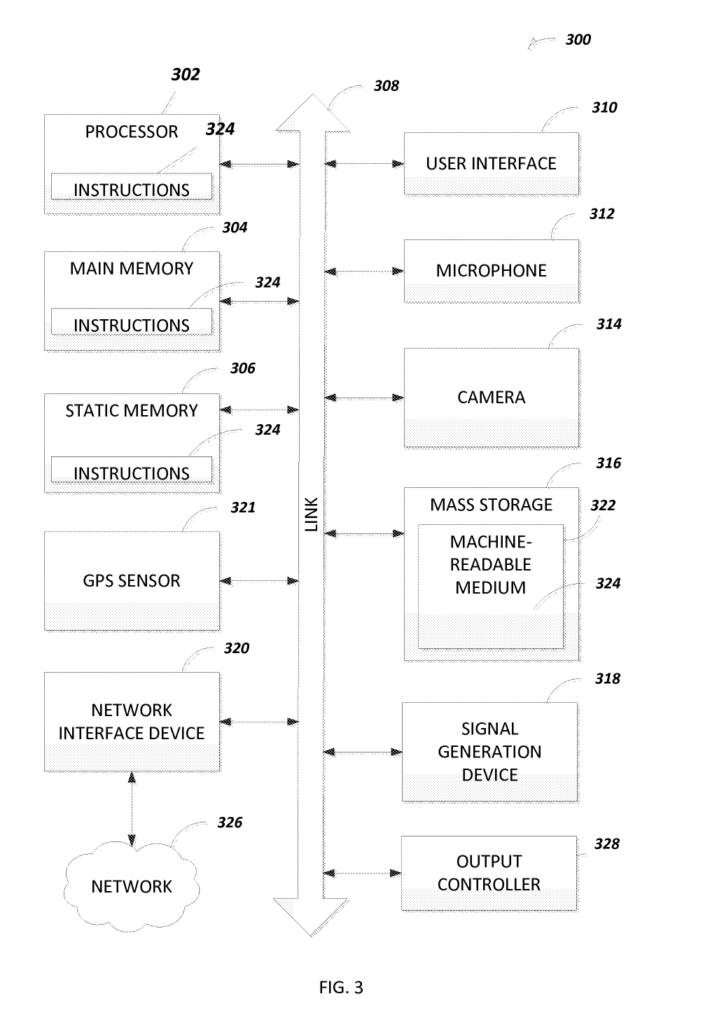

FIG. 3 is a block diagram illustrating an example device 300 upon which any one or more of the techniques discussed herein may be performed. The device may be a tablet PC, a Personal Digital Assistant (PDA), a mobile telephone, a web appliance, or any portable device capable of executing instructions (sequential or otherwise) that specify actions to be taken by that machine. Further, while only a single device is illustrated, the term “device” shall also be taken to include any collection of devices that individually or jointly execute a set (or multiple sets) of instructions to perform any one or more of the methodologies discussed herein.

The example device 300 includes at least one processor 302 (e.g., a central processing unit (CPU), a graphics processing unit (GPU) or both, processor cores, compute nodes, etc.), a main memory 304, and a static memory 306, which communicate with each other via a link 308 (e.g., bus). The device 300 may further include a user interface 310. The user interface 310 may receive a user input of a proximity preference. The proximity preference may indicate a maximum distance that should be maintained between the device 300 and the user 105 (FIG. 1) or between the device 300 and a “buddy” device 205 or 210 (FIG. 2).

The device 300 may additionally include one or more sensors such as a microphone 312, a camera 314, a global positioning system (GPS) sensor 321, or other sensors or interfaces (not shown in FIG. 3) for receiving a Bluetooth signal, a Bluetooth low energy (LE) signal, a near field communications (NFC) signal, or other signal. The microphone 312, the camera 314, or other sensor may sense at least one characteristic of the user 105.

The device 300 302 may be configured to detect, based on at least one characteristic, that the proximity to the user 105 has increased beyond the proximity preference. In an embodiment, the user interface 310 may be configured to receive a plurality of proximity preferences, and the processor 302 may be configured to select one of the proximity preferences for use in detecting whether the proximity to the user 105 has increased beyond the proximity preference. The processor 302 may select the proximity preference to use based on a location of the device 300. For example, a first proximity preference may be used when the user 105 is in his or her office, while a second proximity preference may be used when the user 105 is in a restaurant or nightclub. The location of the device 300 may be received through the GPS sensor 321.

Example embodiments may detect proximity between the user 105 and the device 300 using the microphone 312, the camera 314 or another sensor. In an example embodiment, the processor 302 may recognize a voice characteristic based on a voice signal received through the microphone 312. The processor 302 may determine whether the user 105 is within the proximity distance based on the voice characteristic. For example, if the user 105 is within range of the microphone 312, the processor 302 may determine that the user 105 is within the proximity distance. In an embodiment, the processor 302 may compare the voice characteristics of the voice signal received through the microphone 312 with a voice characteristic of the user 105 previously stored in, for example, the main memory 304, the static memory 306, or a network location.

In an example embodiment, the processor 302 may recognize an image received through the camera 314. The camera 314 may be arranged as a “forward” camera or a “back” camera to capture images on either side of the device. The processor 302 may determine whether the user 105 is within the proximity distance based on the image characteristic. For example, if the user 105 is within range of the camera 314, the processor 302 may determine that the user 105 is within the first proximity distance. In an embodiment, the processor 302 may compare the image characteristics of the image signal received through the camera 314 with an image characteristic of the user 105 previously stored in, for example, the main memory 304, the static memory 306, or a network location.

In an example embodiment, the device 300 may receive signals, for example Bluetooth signals, from a headset or other device worn by the user 105. The processor 302 may detect that the user 105 has moved outside the proximity distance based on a signal strength of the received signals.

The processor 302 may detect that a “buddy” device 205 or 210 (FIG. 2) has moved outside the first proximity distance based on, for example, a strength of a Wi-Fi signal, a Bluetooth signal, a Bluetooth low energy (LE) signal, a near field communications (NFC) signal, or other signal. The type of the signal may depend on, for example, the proximity distance established by the user 105. The processor 302 may determine the distance between “buddy” devices based on one or more of the signal strengths. In some embodiments, a processor 302 may use Wi-Fi access points for triangulating a location of the other buddy device 205 or 210. In some embodiments, a processor 302 may use inertial sensing (using for example an accelerometer, gyro, compass, etc.) to determine the distance traversed by a buddy device 205, 210 relative to the device 300.

In some embodiments, a device 300 may become a proxy for the user 105 to monitor the other buddy device 205, 210. In at least these embodiments, the device 300 may perform calculations detect distance to the other, “non-proxy” buddy device 205, 210. In at least these embodiments, the non-proxy buddy device 205 or 210 may remain in a lower-power state relative to the device 300. The processor 302 may determine that the device 300 should act as the proxy device if, for example, the device 300 is an active state (i.e., the user 105 is interacting with the device 300). The processor 302 may determine that the device 300 should act as the proxy device based on the battery life of the device 300, the operating cost of the device 300, etc.

The processor 302 may generate an alert signal upon determining that the proximity to the user 105, or to the “buddy” device 205 or 210, has increased beyond a proximity preference. The alert signal may be an audible alert, for example, or a haptic alarm such as a vibration. The user 105 or another user may disable the alert signal or the detection mechanism using a voice command or by entering a passcode, for example.

The alert signal may be further customized based on a location of the device 300. The location of the device 300 may be received through the GPS sensor 321. For example, if the device 300 is located in the user 105's office, a message may be generated with details such as the user 105's secretary's name, mail drop, etc.

If the device 300 becomes misplaced, for example if the user 105 moves outside the “proximity bubble,” the processor 302 may initiate security measures to prevent unauthorized usage of the device 300. The processor 302 may monitor for activity using, for example, audio cues received through the microphone 312 or visual cues received through the camera 314. If the processor 302 detects nearby activity, the processor 302 may generate a message or audible signal, such as a chirp, to alert nearby users that the device 300 may have been misplaced. The processor 302 may enter a power save mode by powering the microphone 312 or the camera 314 after periods of inactivity or until a second user picks of the device 300.

Example embodiments may provide assistance to the second user in returning the device 300 to the user 105 or to another person. The processor 302 may be configured to detect, through for example an accelerometer (not shown in FIG. 3) that the device 300 has been picked up by the second user. Based on detecting that the device 300 has been picked up by the second user, or that the second user has come within a distance of the device 300, the processor 302 may “power on” or cause to be powered on, the camera 314, the microphone 312, or other sensors (not shown).

The processor 302 may determine the identity of the second user based on a voice signal received through the microphone 312. In an embodiment, the processor 302 may compare the voice characteristics of the voice signal received through the microphone 312 with a voice characteristic of the second user previously stored in the main memory 304, the static memory 306, or a network location. The voice characteristic of the second user may have previously been stored by the user 105 or another user as part of a contact list. Based on the determined identity of the second user, the processor 302 may generate a message directed to or customized for the second user. The processor 302 may also determine the identity of other nearby users based on a voice signal received through the microphone 312. The processor 302 may generate a message directed to or customized to the other nearby users.

The processor 302 may determine the identity of the second user based on an image received through the camera 314. The camera 314 may be arranged as a “forward” camera or a “back” camera to capture images on either side of the device. In an embodiment, the processor 302 may compare the image characteristics of the image received through the camera 314 with an image of the second user previously stored in the main memory 304 or the static memory 306. The image of the second user may have previously been stored by the user 105 or another user as part of a contact list in the main memory 304 or the static memory 306. Based on the determined identity of the second user, the processor 302 may generate a message directed to or customized for the second user. The processor 302 may also determine the identity of other nearby users based on an image received through the camera 314. The processor 302 may generate a message directed to or customized to the other nearby users.

The device 300 may further include a storage device 316 (e.g., a drive unit), a signal generation device 318 (e.g., a speaker), and a network interface device 320. The storage device 316 includes at least one machine-readable medium 322 on which is stored one or more sets of data structures and instructions 324 (e.g., software) embodying or utilized by any one or more of the methodologies or functions described herein. Instructions 324 may also reside, completely or at least partially, within the main memory 304, static memory 306, and/or within processor 302 during execution thereof by the device 300, with the main memory 304, the static memory 306, and the processor 302 also constituting machine-readable media.

While machine-readable medium 322 is illustrated in an example embodiment to be a single medium, the term “machine-readable medium” may include a single medium or multiple media (e.g., a centralized or distributed database, and/or associated caches and servers) that store the one or more instructions 324. The term “machine-readable medium” shall also be taken to include any tangible medium that is capable of storing, encoding or carrying instructions for execution by the device and that cause the device to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices (e.g., embedded MultiMediaCard (eMMC)); magnetic disks such as internal hard disks and removable disks; magneto-optical disks; and CD-ROM and DVD-ROM disks.

Instructions for implementing software 324 may further be transmitted or received over a communications network 326 using a transmission medium via the network interface device 320 utilizing any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the device, and includes digital or analog communications signals or other intangible medium to facilitate communication of such software.

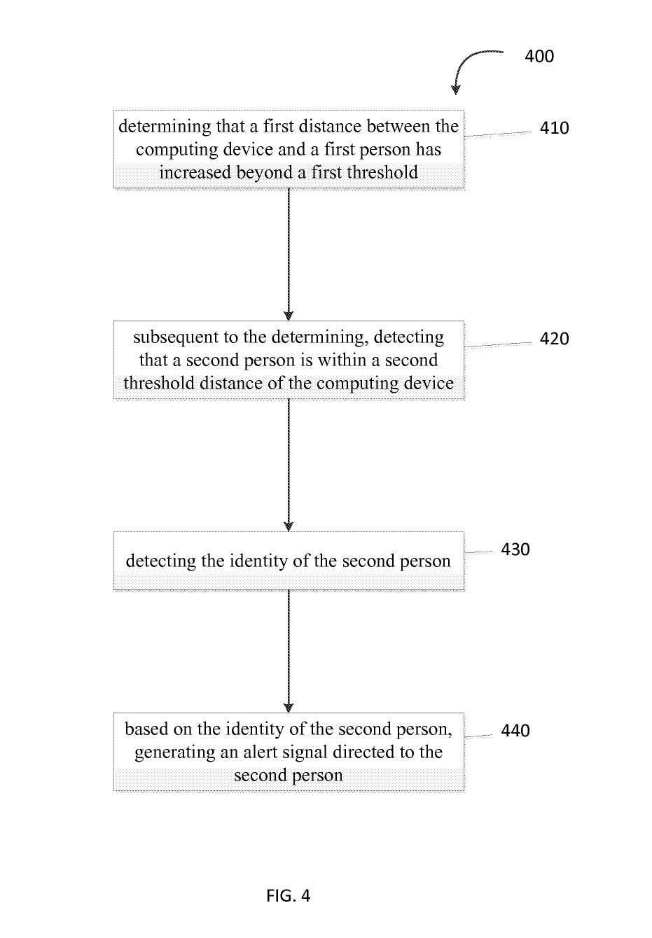

FIG. 4 is a flow diagram illustrating an example method 400 for notifying of a lost device according to an embodiment. The scheme 400 may be implemented, for example, on device 110 of FIG. 1, devices 205 or 210 of FIG. 2, or device 300 of FIG. 3. At block 410, a distance between the computing device and a first person is determined to have increased beyond a threshold. In an embodiment, a determination as to whether the distance between the computing device and the first person has exceeded the proximity preference is made using a voice signal or an image signal as described above with respect to FIG. 3.

At block 420, subsequent to the determining, a second person is detected within a second proximity preference of the computing device. The second proximity preference may be a distance of zero. The second proximity preference may be the same or substantially the same as the first proximity preference.

At block 430, the identity of the second person is detected. In an embodiment, the identity of the second person may be detected using an image or a voice characteristic as discussed above with respect to FIG. 3. In an example embodiment, a voice signal of the second person may be detected. The second person may be determined to be known to the first person using the voice signal and based on a user contact list of the first person. A message may be generated directed to the second person based on the determination. In an example embodiment, the computing device may detect that the computing device has been picked up. A camera may be activated based on the detection. A facial feature of the second person may be detected using the camera. A determination may be made as to whether the second person is known to the first person based at least in part on the facial feature. A message directed to the second person may be generated based on the determining

At block 440, based on the identity of the second person, an alert signal may be generated. In an example embodiment, the alert signal may be a message directed to the second person as described above with respect to FIG. 3.

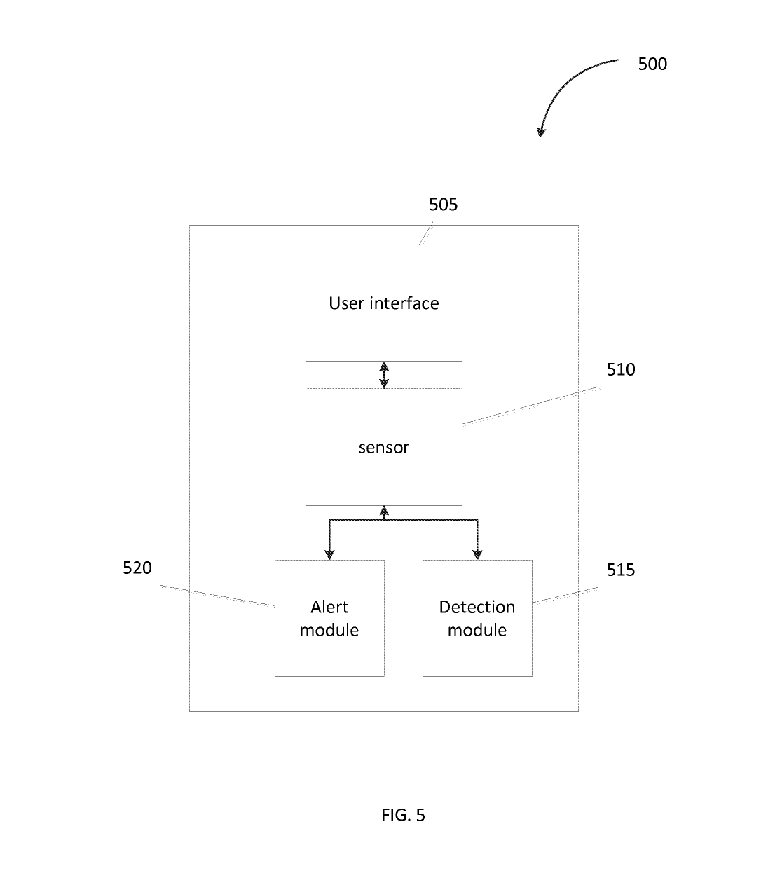

FIG. 5 is a block diagram illustrating an example device 500 upon which any one or more of the techniques discussed herein may be performed. The device may be a tablet PC, a Personal Digital Assistant (PDA), a mobile telephone, a web appliance, or any portable device capable of executing instructions (sequential or otherwise) that specify actions to be taken by that machine. Further, while only a single device is illustrated, the term “device” shall also be taken to include any collection of devices that individually or jointly execute a set (or multiple sets) of instructions to perform any one or more of the methodologies discussed herein.

The device 500 may include a user interface 505. The user interface 505 may receive a user input of a first proximity preference. The first proximity preference may indicate a distance between the computing device and a first user.

The device 500 may include at least one sensor 510.

The device 500 may include a detection module 515. The detection module 515 may determine, based on the at least one characteristic, whether the proximity to the first user has increased beyond the first proximity preference.

The device 500 may include an alert module 520. The alert module 520 may generate an alert signal based on the determination by the detection module 515.

The at least one sensor 510 may sense at least one characteristic of the first user. The at least one sensor 510 may include a microphone. The detection module 515 may recognize a voice characteristic based on a voice signal received through the microphone. The detection module 515 may determine whether the first user is within the first proximity distance based on the voice characteristic. The detection module 515 may identify a second user based on the voice signal and generate a message directed to the second user based on the identifying.

The at least one sensor 510 may include a camera. The detection module 515 may recognize an image characteristic based on an image signal received through the camera. The detection module 515 may determine whether the first user is within the first proximity distance based on the image characteristic. The detection module 515 may identify a second person based on at least one image captured by the camera. The detection module 515 may generate a message addressed to the second person based on the identification.

The at least one sensor 510 may include a sensor for sensing a signal strength of a Wi-Fi signal, a Bluetooth signal, a Bluetooth LE signal, an NFC signal, or other signal. The Wi-Fi signal, the Bluetooth signal, the Bluetooth LE signal, the NFC signal, or other signal, may be generated by a “buddy” device (not shown in FIG. 5). The detection module 515 may generate an alert based on the sensed signal strength as described above with respect to FIG. 3.

The device 500 may include a global positioning system (GPS) component (not shown in FIG. 5). The GPS component may receive a geographic location of the device 500. The user interface 505 may receive a plurality of proximity preferences. The detection module 515 may determine, based on the geographic location of the device 500, which of the two or more proximity preferences to use for determining whether to generate the alert signal.

It will be appreciated that, for clarity purposes, the above description describes some embodiments with reference to different functional units or processors. However, it will be apparent that any suitable distribution of functionality between different functional units, processors or domains may be used without detracting from embodiments. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Examples, as described herein, can include, or can operate on, logic or a number of components, modules, or mechanisms. Modules are tangible entities capable of performing specified operations and can be configured or arranged in a certain manner. In an example, circuits can be arranged (e.g., internally or with respect to external entities such as other circuits) in a specified manner as a module. In an example, the whole or part of one or more computer systems (e.g., a standalone, client or server computer system) or one or more hardware processors can be configured by firmware or software (e.g., instructions, an application portion, or an application) as a module that operates to perform specified operations. In an example, the software can reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, one instantiation of a module may not exist simultaneously with another instantiation of the same or different module. For example, where the modules comprise a general-purpose hardware processor configured using software, the general-purpose hardware processor can be configured as respective different modules at different times. Accordingly, software can configure a hardware processor, for example, to constitute a particular module at one instance of time and to constitute a different module at a different instance of time.

Embodiments may be implemented in one or a combination of hardware, firmware, and software. Embodiments may also be implemented as instructions stored on a computer-readable storage device, which may be read and executed by at least one processor to perform the operations described herein. A computer-readable storage device may include any non-transitory mechanism for storing information in a form readable by a device (e.g., a computer). For example, a computer-readable storage device may include read-only memory (ROM), random-access memory (RAM), magnetic disk storage media, optical storage media, flash-memory devices, and other storage devices and media.

The Abstract of the Disclosure is provided to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### ADDITIONAL NOTES AND EXAMPLES

Additional examples of the presently described method, system, and device embodiments include the following, non-limiting configurations. Each of the following non-limiting examples can stand on its own, or can be combined in any permutation or combination with any one or more of the other examples provided below or throughout the present disclosure.

Example 1 can include subject matter (such as an apparatus, a method, a means for performing acts, or a machine readable medium including instructions that, when performed by the device, that can cause the device to perform acts), to: receive a user input of a first proximity preference, the first proximity preference indicating a distance between the device and a first user; sense at least one characteristic of the first user; determine, based on the at least one characteristic, whether the distance to the first user has increased beyond the first proximity preference; and generate an alert signal based on the determination.

In Example 2, the subject matter of Example 1 can optionally include receiving a geographic location of the device; receiving a plurality of proximity preferences; and determining, based on the geographic location of the device, which of the plurality of proximity preferences to use for determining whether to generate the alert signal.

In Example 3, the subject matter of one or any combination of Examples 1 or 2 can optionally include recognizing a voice characteristic based on a voice signal received through a microphone; and determining whether the first user is within the first proximity preference based on the voice characteristic.

In Example 4, the subject matter of one or any combination of Examples 1-3 can optionally include identifying a second user based on the voice signal; and generating a message directed to the second user based on the identifying.

In Example 5 the subject matter of one or any combination of Examples 1-5 can optionally include recognizing an image characteristic based on an image signal received through a camera; and determining whether the first user is within the first proximity preference based on the image characteristic.

In Example 6, the subject matter of one or any combination of Examples 1-5 can optionally include identifying a second user based on at least one image captured by the camera; and generating a message addressed to the second user based on the identification.

In Example 7, the subject matter of one or any combination of Examples 1-6 can optionally include generating an alert if a second device, coupled to the device, is outside the first proximity preference.

Example 8 can include subject matter (such as an apparatus, a method, a means for performing acts, or a machine readable medium including instructions that, when performed by the device, that can cause the device to perform acts), to: receive a user input including a first proximity preference; detect that a distance between the computing device and a user of the computing device has increased beyond the first proximity preference, the detecting being based on sensing a characteristic of the user; and generate an alert signal based on the detecting.

Example 9 can include, or can optionally be combined with the subject matter of Example 8, to optionally include receiving a voice signal; recognizing a voice characteristic of the voice signal; and determining that the user is within the first proximity distance if the voice characteristic is a voice characteristic of the user.

Example 10 can include, or can optionally be combined with the subject matter of Examples 8 or 9, to optionally include receiving an image signal; recognizing a facial characteristic of an image formed at least in part using the image signal; recognizing an image based on the facial characteristic; and determining that the user is within the first proximity distance if the image is an image of the user.

Example 11 can include, or can optionally be combined with the subject matter of Examples 8-10, to optionally include detecting that a distance between the computing device and the user of the computing device has increased beyond the first proximity preference if a signal strength of a headset worn by the user decreases below a threshold.

Example 12 can include, or can optionally be combined with the subject matter of Examples 8-11, to optionally include receiving a second user input including a second proximity preference; selecting, for use in the detecting and based on a geographic location of the computing device, one of the first proximity preference and the second proximity preference based on a geographic location of the computing device; and detecting that the distance between the computing device and the user has increased beyond the selected one of the first proximity preference and the second proximity preference.

Example 13 can include, or can optionally be combined with the subject matter of Examples 8-12, to optionally include detecting that a distance between the computing device and a second computing device has increased beyond the first proximity preference.

Example 14 can include, or can optionally be combined with the subject matter of Examples 8-13, to optionally include receiving an input to disable the instructions to detect.

Example 15 can include, or can optionally be combined with the subject matter of Examples 8-14, to optionally include receiving an input to disable the alert signal after the alert signal has been generated.

Example 16 can include, or can optionally be combined with the subject matter of Examples 8-15, to optionally include receiving a voice command to disable the alert signal after the alert signal has been generated.

Example 17 can include, or can optionally be combined with the subject matter of Examples 8-16, to optionally include receiving an input to disable the alert signal after the alert signal has been generated.

Example 18 can include subject matter (such as an apparatus, a method, a means for performing acts, or a machine readable medium including instructions that, when performed by the device, can cause the device to perform acts), to: detect that a first person is within a proximity of the lost device; detect the identity of the first person; and based on the identity of the first person, generate an alert signal directed to the first person.

Example 19 can include, or can optionally be combined with the subject matter of Example 18, to optionally include detecting the first person only subsequently to determining that a first distance between the lost device and a second person has increased beyond a proximity preference.

Example 20 can include, or can optionally be combined with the subject matter of Examples 18-19, to optionally include detecting a voice signal of the first person; determining, using the voice signal, whether the first person is known to the first second based on a user contact list of the second person; and generating a message directed to the first person based on the determination.

Example 21 can include, or can optionally be combined with the subject matter of Examples 18-20, to optionally include detecting that the computing device has been picked up; activating a camera based on the detection; detecting a facial feature of the first person using the camera; determining whether the first person is known to the second person based at least in part on the facial feature; and generating a message directed to the first person based on the determining

What is claimed is:

1. A device comprising:
a user interface to receive a user input of a first proximity preference, the first proximity preference indicating a distance between the device and a first user;
at least one sensor to sense at least one characteristic of the first user;
a detection module to determine, based on the at least one characteristic, whether the distance to the first user has increased beyond the first proximity preference, and
an alert module to generate an alert signal based on the determination.

2. The device of claim 1, further comprising:
a global positioning system (GPS) component to receive a geographic location of the device, and wherein
the user interface is configured to receive a plurality of proximity preferences, and
the detection module is configured to determine, based on the geographic location of the device, which of the plurality of proximity preferences to use for determining whether to generate the alert signal.

3. The device of claim 1, further comprising:
a microphone, and wherein the detection module is further configured to
recognize a voice characteristic based on a voice signal received through the microphone, and
determine whether the first user is within the first proximity preference based on the voice characteristic.

4. The device of claim 3, wherein the detection module is further configured to:
identify a second user based on the voice signal; and
generate a message directed to the second user based on the identifying.

5. The device of claim 1, further comprising:
a camera, and wherein the detection module is further configured to,
recognize an image characteristic based on an image signal received through the camera, and
determine whether the first user is within the first proximity preference based on the image characteristic.

6. The device of claim 5, wherein the detection module is further configured to:
identify a second user based on at least one image captured by the camera; and
generate a message addressed to the second user based on the identification.

7. The device of claim 1, wherein the detection module is further configured to:
generate an alert if a second device, coupled to the device, is outside the first proximity preference.

8. At least one machine-readable storage medium comprising a plurality of instructions that in response to being executed on a computing device, cause the computing device to:
receive a user input including a first proximity preference;
detect that a distance between the computing device and a user of the computing device has increased beyond the first proximity preference, the detecting being based on sensing a characteristic of the user; and
generate an alert signal based on the detecting.

9. The at least one machine-readable storage medium of claim 8, wherein the machine-readable storage medium further comprises instructions to:
receive a voice signal;
recognize a voice characteristic of the voice signal; and
determine that the user is within the first proximity distance if the voice characteristic is a voice characteristic of the user.

10. The at least one machine-readable storage medium of claim 8, wherein the detecting further comprises instructions to
receive an image signal;
recognize a facial characteristic of an image formed at least in part using the image signal;
recognize an image based on the facial characteristic; and
determine that the user is within the first proximity distance if the image is an image of the user.

11. The at least one machine-readable storage medium of claim 8, further comprising instructions to:
detect that a distance between the computing device and the user of the computing device has increased beyond the first proximity preference if a signal strength of a headset worn by the user decreases below a threshold.

12. The at least one machine-readable storage medium of claim 8, further comprising instructions to:
receive a second user input including a second proximity preference;
select, for use in the detecting and based on a geographic location of the computing device, one of the first proximity preference and the second proximity preference based on a geographic location of the computing device; and
detect that the distance between the computing device and the user has increased beyond the selected one of the first proximity preference and the second proximity preference.

13. The at least one machine-readable storage medium of claim 8, further comprising instructions to detect that a distance between the computing device and a second computing device has increased beyond the first proximity preference.

14. The at least one machine-readable storage medium of claim 8, further comprising instructions to receive an input to disable the instructions to detect.

15. The at least one machine-readable storage medium of claim 8, further comprising instructions to receive an input to disable the alert signal after the alert signal has been generated.

16. The at least one machine-readable storage medium of claim 15, wherein the input is a voice command.

17. The at least one machine-readable storage medium of claim 15, wherein the input is a passcode.

18. A method for notifying of a lost device, the method comprising:
detecting that a first person is within a proximity of the lost device;
determine the identity of the first person; and
based on the identity of the first person, generating an alert signal directed to the person.

19. The method of claim 18, further comprising:
the first person is determined subsequently to determining that a first distance between the lost device and a second person has increased beyond a proximity preference.

20. The method of claim 18, wherein detecting the identity comprises:
detecting a voice signal of the first person;
determining, using the voice signal, whether the first person is known to the first second based on a user contact list of the second person; and
generating a message directed to the first person based on the determination.

21. The method of claim 18, wherein detecting the identity further comprises:
detecting that the computing device has been picked up;
activating a camera based on the detection;
detecting a facial feature of the first person using the camera;
determining whether the first person is known to the second person based at least in part on the facial feature; and
generating a message directed to the first person based on the determining.
